(19) United States
(12) Patent Application Publication
(10) Pub. No.: US 2022/0083935 A1
(43) Pub. Date: Mar. 17, 2022

(54) Cross-Domain Coordinating Device and Business Outsourcing Management Method

(71) Applicant: Hitachi, Ltd., Tokyo (JP)

(72) Inventors: Teppei INOUE, Tokyo (JP); Tazu NOMOTO, Tokyo (JP)

(21) Appl. No.: 17/409,401

(22) Filed: Aug. 23, 2021

(30) Foreign Application Priority Data
Sep. 15, 2020 (JP) 2020-154693

(51) Int. Cl. G06Q 10/06; G06Q 50/04; G06Q 40/02

(52) U.S. Cl. CPC G06Q 10/0637; G06Q 10/06313; G06Q 40/025; G06Q 50/04; G06Q 10/0633

(57) ABSTRACT

To divide a request content according to QCD and to present a combination of outsourcees. A business outsourcing management device, including: a division plan derivation unit configured to derive a plurality of division plans in which a business related to manufacturing a product is divided into a plurality of processes; an evaluation unit configured to extract and assign a company capable of responding to a requirement of the processes for each division plan and evaluate the division plans according to a predetermined index value; and an outsourcee determination unit configured to determine a business outsourcee according to a division plan with a high evaluation among the division plans.

### BACKGROUND OF THE INVENTION

### 1. Field of the Invention

The present invention relates to a cross-domain coordinating device and a business outsourcing management method.

### 2. Description of the Related Art

A technique in JP-A-2019-211846 is described as the related art related to a business matching service. JP-A-2019-211846 describes that “A management server 40 extracts a technical item indicating an item related to a technique to be used from registered case information, sets a degree of relevance indicating a height of relevance between the case information and the technical item, and generates a trend map which is image information that visualizes the set degree of relevance between the technical items.”

In the technique in JP-A-2019-211846, a company that possesses equipment and technique that match a request content is selected, but an outsourcee is not evaluated from a viewpoint of QCD of quality, cost, and delivery. Even if the request content is a work including a plurality of processes, it is a technique that is supposed to make all the processes outsourced to one company.

### SUMMARY OF THE INVENTION

An object of the invention is to provide a technique that divides a request content according to the QCD and presents a combination of outsourcees.

The present application includes a plurality of units that solves at least a part of the above problems. An example of the units is as follows.

An aspect of the invention is a business outsourcing management device, including: a division plan derivation unit configured to derive a plurality of division plans in which a business related to manufacturing a product is divided into a plurality of processes; an evaluation unit configured to extract and assign a company capable of responding to a requirement of the processes for each division plan and evaluate the division plans according to a predetermined index value; and an outsourcee determination unit configured to determine a business outsourcee according to a division plan with a high evaluation among the division plans.

According to the invention, a request content can be divided according to the QCD and a combination of outsourcees can be presented.

Problems, configurations, and effects other than those described above will be clarified by the following descriptions of embodiments.

### BRIEF DESCRIPTION OF THE DRAWINGS

FIG. 1 is a diagram showing an example of a functional block of a cross-domain coordinating device.

FIG. 2 is a diagram showing an example of a data structure of request information.

FIG. 3 is a diagram showing an example of a data structure of production process information.

FIG. 4 is a diagram showing an example of a data structure of company information.

FIG. 5 is a diagram showing an example of a data structure of equipment information.

FIG. 6 is a diagram showing an example of a data structure of request content division plan information.

FIG. 7 is a diagram showing an example of a data structure of matching information.

FIG. 8 is a diagram showing an example of a data structure of QCD evaluation information.

FIG. 9 is a diagram showing an example of a data structure of outsourcee information.

FIG. 10 is a diagram showing a hardware configuration example of the cross-domain coordinating device.

FIG. 11 is a flowchart showing an example of a value chain configuration processing.

FIG. 12 is a diagram showing an example of derived division plans.

FIG. 13 is a diagram showing an example of an output screen.

### DESCRIPTION OF THE PREFERRED EMBODIMENTS

In the following embodiments, a description may be divided into a plurality of sections or aspects if necessary for convenience. Unless particularly specified, the sections or aspects are not independent of each other, but have a relation in which one section or aspect is a modification, detailed description, supplementary description, or the like of a part or all of another section or aspect.

In the following embodiments, when a number and the like (including the number, a numeric value, an amount, a range, and the like) of an element is referred to, the number and the like are not limited to the specific numbers, and the values may be equal to or greater than or equal to or less than these specific numbers, unless explicitly and particularly specified or unless the number and the like are clearly limited to specific numbers in principle.

In the following embodiments, it is needless to say that constituent elements (including an element step and the like) are not necessarily essential unless explicitly and particularly specified or clearly considered as essential in principle.

Similarly, in the embodiments described below, when a shape, a positional relation, and the like of the constituent elements and the like are mentioned, the substantially approximate or similar shape and the like are included unless explicitly and particularly specified or unless it is considered that this is not the case in principle. The same applies to the numerical value and the range.

In all the drawings for describing the embodiments, in principle, the same members are denoted by the same reference numerals, and repetitive descriptions thereof will be omitted. Hereinafter, each embodiment of the invention will be described with reference to the drawings.

In the present description, a case means an order from a request company, and registration information of the case includes a request company name, a request content, and the like.

A term production process is not limited to production, but means an entire process of supplying products such as design, production, and quality control to a market.

Traditionally, in the manufacturing industry, it is common to design and produce a product in-house and supply the product to a consumer. However, in recent years, in order to expand sales of new businesses and follow changes in a business environment, a need to outsource a business is increasing, and a business matching service that determines an outsourcee according to a request content is expanding.

Meanwhile, even if such a matching service is used, for example, when requesting to provide a product including four processes of product design, part manufacturing, finished product assembly, and quality control, if quality of work in each process is biased, the quality may not reach the standard even if the product can be produced on time and within cost.

In that case, if a process of requesting according to outsourcing candidates can be divided and integrated, it can be expected to provide a low-cost product with a high quality, for example, by outsourcing the product design to a venture company A, the part manufacturing to a low-cost company B, and the finished product assembly and quality control to an experienced company C.

Hereinafter, an embodiment of a cross-domain coordinating device according to the invention will be described with reference to the drawings.

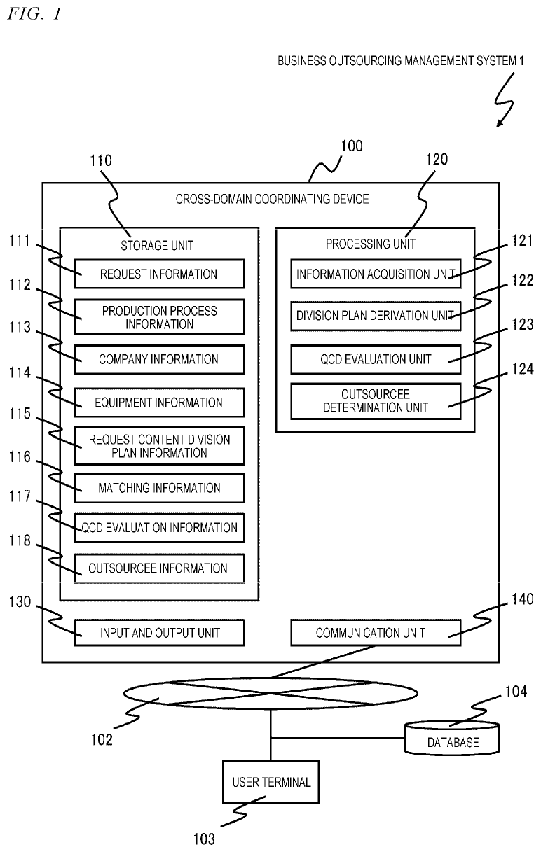

FIG. 1 is a diagram showing an example of a functional block of the cross-domain coordinating device. A cross-domain coordinating device 100 according to the present embodiment is communicably connected to, via a network 102, a user terminal 103 to be used by a user and a database 104 in which data is stored, to constitute a business outsourcing management system 1. The cross-domain coordinating device 100 is an information processing device that is responsible for proposing, implementing, and managing business outsourcing in the manufacturing industry particularly (not limited to computer-related products, but also includes hardware and software), and can be said to be a business outsourcing management device.

The network 102 communicably connects the user terminal 103, the database 104, and the cross-domain coordinating device 100. The network 102 is, for example, any one or a combination of a communication network using a part or all of general public lines such as a local area network (LAN), a wide area network (WAN), a virtual private network (VPN), and an Internet, a mobile phone communication network, and the like. The network 102 may be a wireless communication network such as Wi-Fi (registered trademark) or 5G (Generation).

The user terminal 103 is an information processing device such as a personal computer (PC). A user issues a processing execution instruction to the cross-domain coordinating device 100 via the user terminal 103. The user terminal 103 has a function of displaying information output by the cross-domain coordinating device 100 to the user.

The database 104 is, for example, a system such as an enterprise resources planning (ERP), or a database that stores data equivalent to the system, or a storage device.

The cross-domain coordinating device 100 is an information processing device including a storage unit 110, a processing unit 120, an input and output unit 130, and a communication unit 140.

Request information 111, production process information 112, company information 113, equipment information 114, request content division plan information 115, matching information 116, QCD evaluation information 117, and outsourcee information 118 are stored in the storage unit 110.

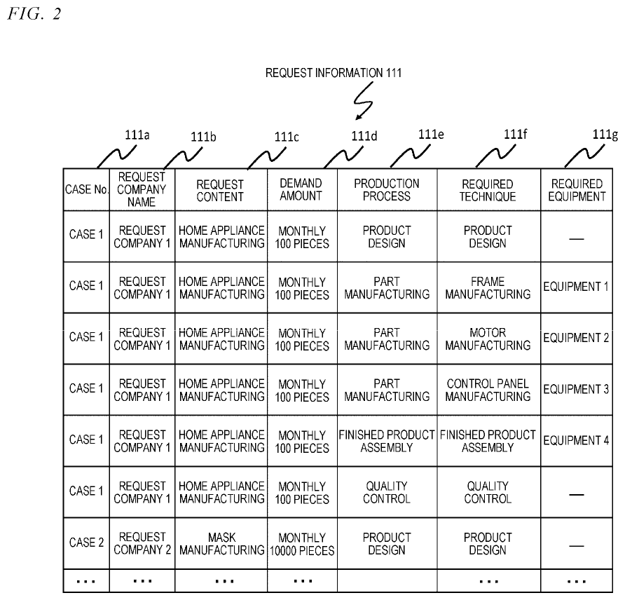

FIG. 2 is a diagram showing an example of a data structure of request information. In the request information 111, information on request content of each case is stored, and a case No. 111a, a request company name 111b, a request content 111c, a demand amount 111d, a production process 111e, a required technique 111f, and required equipment 111g are stored in association with each other.

The case No. 111a is number information that identifies a business to be ordered. The request company name 111b is a name of a company that is an outsourcer of the business. The request content 111c is information that indicates a business content requested by the outsourcer. For example, “Case 1” in the case No. 111a in FIG. 2 is a case for ordering “home appliance manufacturing” which is the request content 111c. The demand amount 111d indicates the number of requests from a market in the future. For example, “Case 1” in the case No. Main FIG. 2 indicates that a monthly demand (order quantity) is 100 pieces.

The production process 111e is information that indicates a production process constituting the request content. The required technique 111f is information that indicates a technique required in the production process. For example, it is shown that for the “Case 1” in the case No. 111a in FIG. 2, a “product design” technique is required for “product design” in the production process 111e, and “frame manufacturing”, “motor manufacturing”, and “control panel manufacturing” are required for “part manufacturing” in the production process 111e.

The required equipment 111g is information that indicates equipment required for each production process. For example, “Equipment 1”, “Equipment 2”, and “Equipment 3” are required for the “part manufacturing” in the production process 111e of the “Case 1” in the case No. 111a in FIG. 2. If the equipment is not required as in the “product design” in the production process 111e, “-” is stored in the equipment.

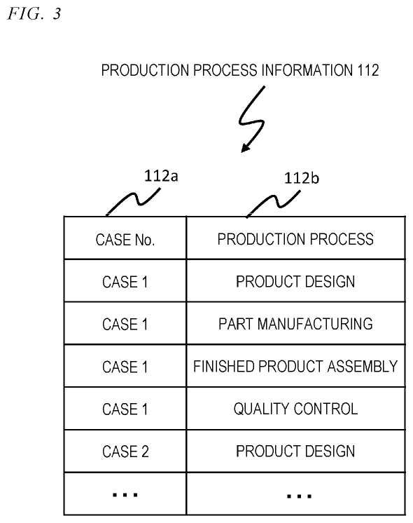

FIG. 3 is a diagram showing an example of a data structure of production process information. In the production process information 112, information on the production processes of the cases registered in the request information 111 is stored, and a case No. 112a and a production process 112b are stored in association with each other. For example, for the “Case 1” in the case No. 112a in FIG. 3, the “product design”, the “part manufacturing”, the “finished product assembly”, and the “quality control” are stored as the production process 112b. In addition, the production processes may include processes such as transportation, export, and inspection, and these processes may be included in the manufacturing and assembly processes.

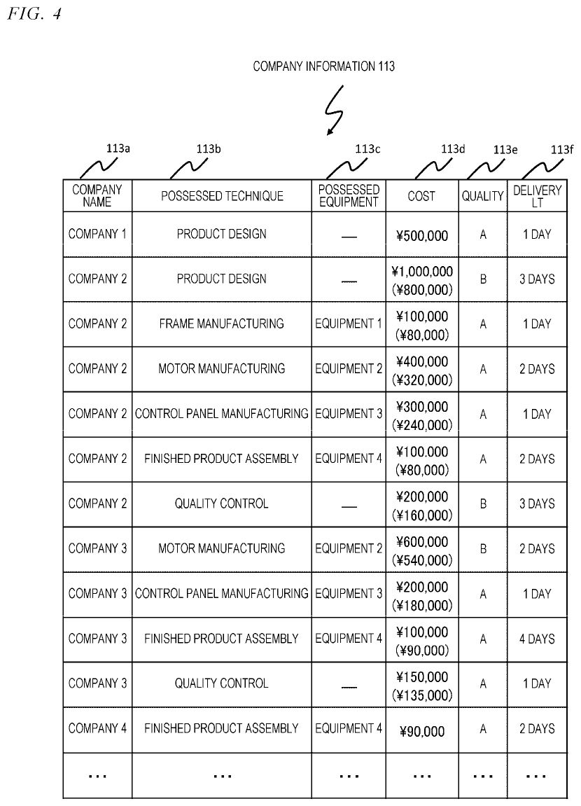

FIG. 4 is a diagram showing an example of a data structure of company information. Information on a company who is a candidate of a business outsourcee of each production process is stored in the company information 113. In the company information 113, a company name 113a, a possessed technique 113b, possessed equipment 113c, a cost 113d, quality 113e, and delivery LT (LT: lead time) 113f are stored in association with each other.

The company name 113a is a name of the candidate company of the business outsourcee. The possessed technique 113b is information that indicates a technique that can be possessed or utilized by the company specified by the company name 113a. For example, “Company 1” in the company name 113a in FIG. 4 can possess or utilize the “product design” technique.

The possessed equipment 113c is a name of equipment that can be possessed or utilized among pieces of equipment related to the possessed technique. In the possessed equipment 113c, if equipment that can be possessed or utilized exists, a name of the equipment is stored, and if the equipment that can be possessed or utilized does not exist, “-” is stored. For example, since the “Company 1” in the company name 113a in FIG. 4 does not possess the equipment that can be possessed or utilized in the “product design” in the possessed technique 113b, “-” is stored in the possessed equipment 113c in the record.

The cost 113d indicates a cost to be paid when an outsourcing company outsources a business to the outsourcee company. When the outsourcee company has a plurality of techniques, a discounted cost in a case where the outsourcing company outsources a business related to the plurality of techniques is stored in parentheses H in the cost 113d. For example, in “Company 2” in the company name 113a in FIG. 4, if the “frame manufacturing” in the possessed technique 113b is outsourced alone, a compensation that the outsourcer should pay to the “Company 2” is “¥100,000”, but if other techniques are also outsourced, the compensation becomes “¥80,000” in the parentheses.

The quality 113e is information that indicates a quality evaluation on a possessed technique of the company. The delivery LT 113f indicates a period required to execute the possessed technique of the company. For example, for the “Company 1” in the company name 113a in FIG. 4, it is stored that “1 Day” is required as the delivery LT for the “product design” in the possessed technique 113b.

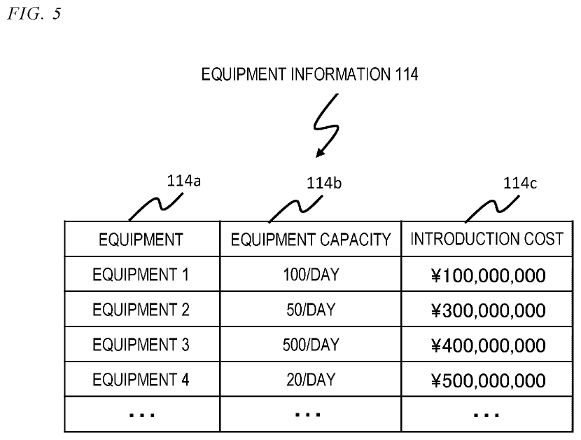

FIG. 5 is a diagram showing an example of a data structure of equipment information. In the equipment information 114, information on a unit required when adding equipment and on an introduction cost is stored, and equipment 114a, an equipment capacity 114b, and an introduction cost 114c are stored in association with each other. The equipment capacity 114b indicates a capacity per unit of equipment, and the introduction cost 114c indicates a cost required to add one unit of the equipment.

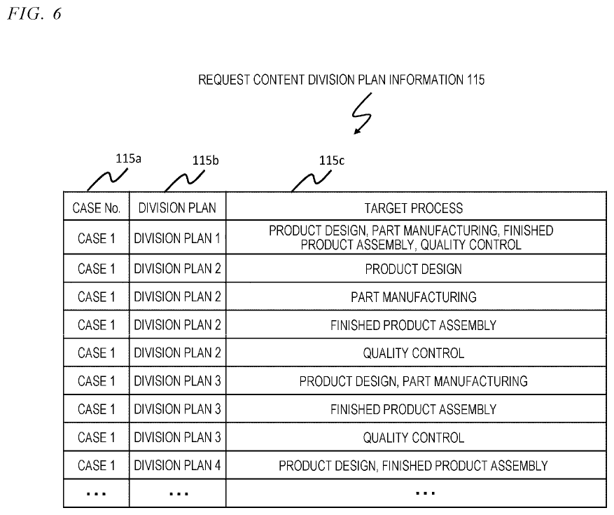

FIG. 6 is a diagram showing an example of a data structure of request content division plan information. In the request content division plan information 115, a plurality of plans obtained by dividing the request content of the case registered in the request information 111 according to production processes are stored as division plans, and a case No. 115a, a division plan 115b, and a target process 115c are stored in association with each other.

The case No. 115a is number information that identifies a business to be ordered. The division plan 115b is number information that identifies a division plan of a request content. The target process 115c indicates a unit of a production process to be requested to the business outsourcee company among all the production processes of the request content.

For example, if the division plan 115b in FIG. 6 is “Division Plan 1”, the target process 115c does not divide the request content in “product design, part manufacturing, finished product assembly, quality control”, and outsources all the production processes to a single company. Meanwhile, if the division plan 115b is “Division Plan 2”, the target processes are “product design”, “part manufacturing”, “finished product assembly”, and “quality control” which are independent of each other, that is, each production process is outsourced to another company.

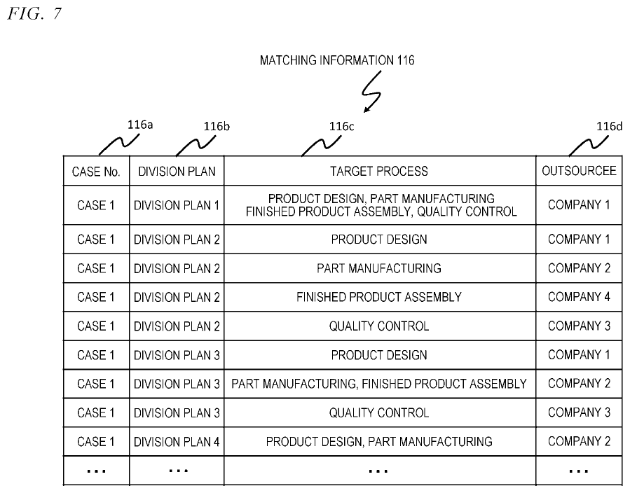

FIG. 7 is a diagram showing an example of a data structure of matching information. In the matching information 116, a matching result of the outsourcees for the division plans registered in the request content division plan information 115 is stored, and a case No. 116a, a division plan 116b, a target process 116c, and an outsourcee 116d are stored in association with each other.

The case No. 116a, the division plan 116b, and the target process 116c are the same information as the case No. 115a, the division plan 115b, and the target process 115c of the request content division plan information 115, respectively.

The outsourcee 116d is a name of a business outsourcee company of the target process. For example, if the division plan 116b of “Case 1” in the case No. 116a in FIG. 7 is “Division Plan 3”, the “product design” is outsourced to “Company 1”, “part manufacturing, finished product assembly” is outsourced to “Company 2”, and the “quality control” is outsourced to “Company 3”.

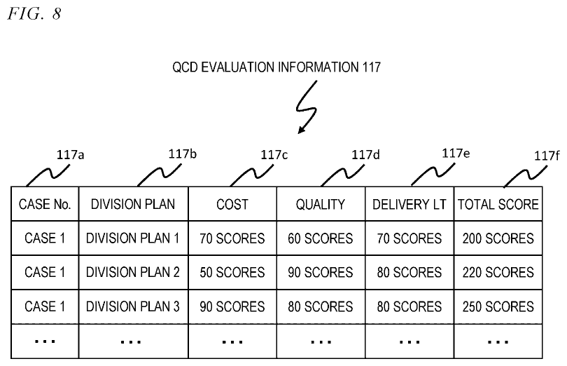

FIG. 8 is a diagram showing an example of a data structure of QCD evaluation information. The QCD (quality, cost, delivery LT: lead time) and a comprehensive evaluation result for the division plans stored in the request content division plan information 115 are stored in the QCD evaluation information 117. In the QCD evaluation information 117, a case No. 117a, a division plan 117b, a cost 117c, a quality 117d, a delivery LT 117e, and a total score 117f are stored in association with each other.

The cost 117c is information that indicates an evaluation result of a cost aspect for each division plan 117b. For example, for the “Division Plan 1” in the division plan 117b in FIG. 8, it is indicated that the cost 117c is “70 scores”.

The quality 117d is information that indicates an evaluation result of a quality aspect for each division plan 117b. For example, for the “Division Plan 1” in the division plan 117b in FIG. 8, it is indicated that the quality 117d is “60 scores”.

The delivery LT 117e is information that indicates an evaluation result of a delivery LT aspect for each division plan 117b. For example, for the “Division Plan 1” in the division plan 117b in FIG. 8, it is indicated that the delivery LT 117e is “70 scores”.

The total score 117f is information that indicates a QCD comprehensive evaluation result for each division plan 117b. For example, for the “Division Plan 1” in the division plan 117b in FIG. 8, it is indicated that the total score 117f is “200 scores”.

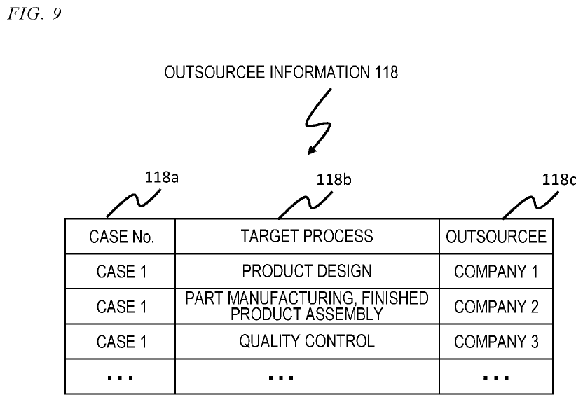

FIG. 9 is a diagram showing an example of a data structure of outsourcee information. In the outsourcee information 118, a final outsourcee selection result is stored, and a case No. 118a, a target process 118b, and an outsourcee 118c are stored in association with each other.

The description now returns to FIG. 1. The processing unit 120 includes an information acquisition unit 121, a division plan derivation unit 122, a QCD evaluation unit 123, and an outsourcee determination unit 124.

The information acquisition unit 121 acquires information required for processing of the division plan derivation unit 122, the QCD evaluation unit 123, and the outsourcee determination unit 124 from the storage unit 110, and stores the acquired result in the storage unit 110.

The division plan derivation unit 122 derives the division plans of the request content of each case from the request information 111 and the production process information 112, and stores the division plans in the request content division plan information 115.

The QCD evaluation unit 123 uses results obtained by reading out the request information 111, the company information 113, the equipment information 114, and the request content division plan information 115 to perform an outsourcee company selection processing and a QCD evaluation processing for division plans of each case, and stores the processing results in the matching information 116 and the QCD evaluation information 117.

The outsourcee determination unit 124 selects a division plan with a highest evaluation from the results obtained by reading out the QCD evaluation information 117, and stores the division plan in the outsourcee information 118.

The input and output unit 130 receives input information input by a keyboard, a mouse, a touch panel, and the like on the user terminal 103, and creates information for displaying the processing results on the user terminal 103. For example, the input and output unit 130 has a function of transmitting the QCD evaluation information 117 and the outsourcee information 118 stored in the storage unit 110 to the user terminal 103 and displaying the results to the user.

The communication unit 140 is communicably connected to the user terminal 103 and the database 104 via the network 102. For example, the communication unit 140 receives the request information 111, the production process information 112, the company information 113, and the equipment information 114 from the database 104, and stores the information in the storage unit 110. In addition, the communication unit 140 receives an input operated by the user at the user terminal 103 and transmits the processing result.

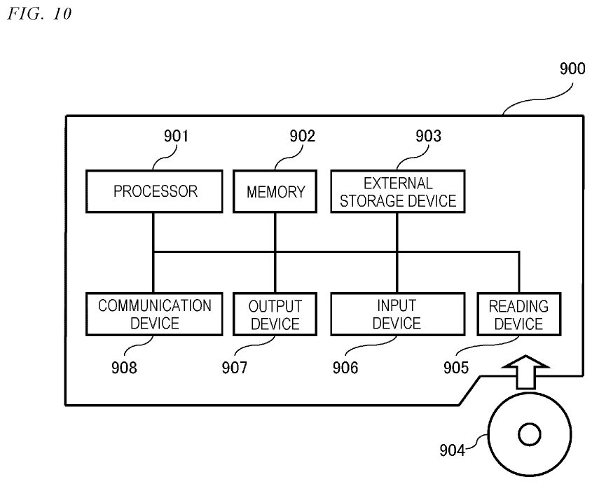

FIG. 10 is a diagram showing a hardware configuration example of the cross-domain coordinating device. The cross-domain coordinating device 100 can be implemented by a general computer 900 including a processor (for example, CPU: Central Processing Unit or GPU: Graphics Processing Unit) 901, a memory 902 such as RAM: Random Access Memory, an external storage device 903 such as a hard disk drive (HDD), a reading device 905 that reads information from a portable storage medium 904 such as a compact disk (CD) or a digital versatile disk (DVD), an input device 906 such as a keyboard, a mouse, and a barcode reader, an output device 907 such as a display, and a communication device 908 that communicates with another computer via a communication network such as Internet. Alternatively, the cross-domain coordinating device 100 can be implemented by a network system including a plurality of the computers 900. It is needless to say that the reading device 905 may be capable of writing as well as reading the portable storage medium 904.

For example, the information acquisition unit 121, the division plan derivation unit 122, the QCD evaluation unit 123, and the outsourcee determination unit 124 included in the processing unit 120 can be implemented by loading a predetermined program stored in the external storage device 903 into the memory 902 and executing the predetermined program in the processor 901. The input and output unit 130 can be implemented by the processor 901 using the input device 906 and the output device 907, the communication unit 140 can be implemented by the processor 901 using the communication device 908, and the storage unit 110 can be implemented by the processor 901 using the memory 902 or the external storage device 903.

The predetermined program may be downloaded into the external storage device 903 from the portable storage medium 904 via the reading device 905 or from the network 102 via the communication device 908, and then may be loaded onto the memory 902 and executed by the processor 901. In addition, the predetermined program may be directly loaded onto the memory 902 from the portable storage medium 904 via the reading device 905 or from the network via the communication device 908, and then may be executed by the processor 901.

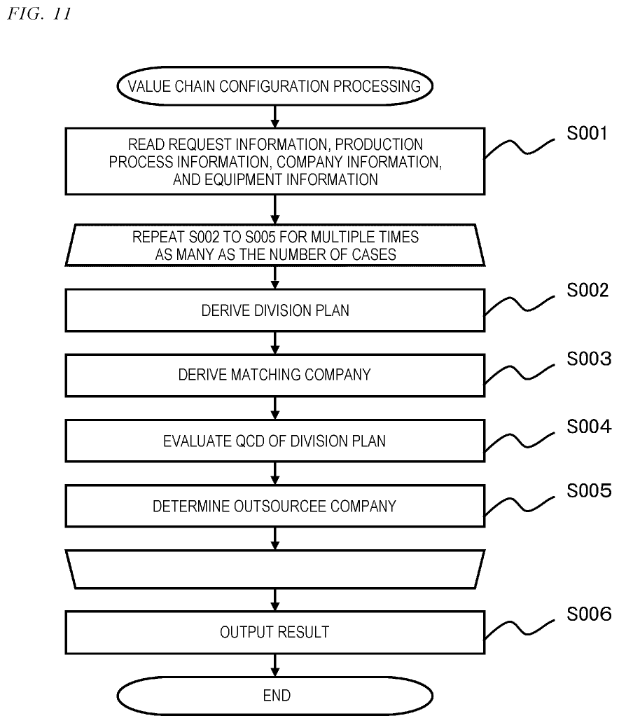

FIG. 11 is a flowchart showing an example of a value chain configuration processing. In a state that the predetermined numbers of the request information 111, the production process information 112, the company information 113, and the equipment information 114 are recorded in the database 104, the value chain configuration processing is started when, for example, the user terminal 103 receives a start command from the user and is handed over to the cross-domain coordinating device 100.

First, the information acquisition unit 121 reads the request information 111, the production process information 112, the company information 113, and the equipment information 114 from the database 104 via the network 102, and stores the information in the storage unit 110 (step S001).

Next, the processing unit 120 repeats processing from a step S002 to a step S005, which will be described later, for multiple times as many as the number of cases stored in the request information 111.

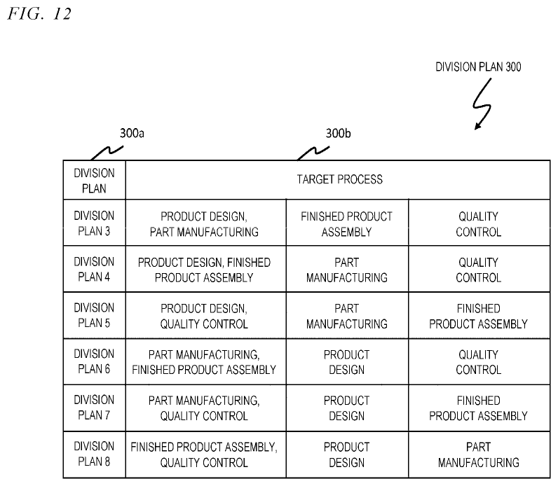

The division plan derivation unit 122 reads the request information 111 and the production process information 112, and generates a plurality of division plans for the case according to the production processes (step S002). For example, since the “Case 1” has four production processes of the “product design”, the “part manufacturing”, the “finished product assembly”, and the “quality control”, it is conceivable to divide the request content into up to four. When generating division plans for a case, the division plan derivation unit 122 lists all possible combinations of the production processes. For example, when the request content of the “Case 1” is divided into three, the division plan derivation unit 122 generates six kinds of division plans as shown in FIG. 12. The division plan derivation unit 122 stores the derivation result in the request content division plan information 115.

In the present embodiment, the division plans are derived according to the production processes, and the request content may be divided according to the required techniques and the required equipment registered in the request information 111.

FIG. 12 is a diagram showing an example of the derived division plans. A division plan 300 shows a round-robin division plan assuming a case where three business outsourcing contracts are made when there are four target processes. A division plan 300a is information that distinguishes a division plan from other division plans, and a target process 300b is a unique combination in which the four target processes are assigned to the three business outsourcing contracts.

Next, the QCD evaluation unit 123 derives a matching company for each target process of the division plan (step S003). Specifically, the QCD evaluation unit 123 extracts, from the company information 113, a company that possesses the required techniques and the required equipment for the cases registered in the request information 111 as a candidate for each case.

For example, the QCD evaluation unit 123 acquires the target processes of each division plan with reference to the request content division plan information 115, and extracts the required techniques and the required equipment for the target processes from the request information 111. In the example of FIG. 6, target processes of the “Division Plan 2” include the “product design”, the “part manufacturing”, the “finished product assembly”, and the “quality control”, and the QCD evaluation unit 123 extracts the required techniques and the required equipment from the request information 111 for each target process. As a result, in case of the “part manufacturing”, the QCD evaluation unit 123 extracts the “frame manufacturing”, the “motor manufacturing”, and the “control panel manufacturing” as the required techniques, and extracts the “Equipment 1”, the “Equipment 2”, and the “Equipment 3” as the required equipment.

The QCD evaluation unit 123 extracts a company that possesses both the extracted required techniques and the required equipment from the company information 113 as an outsourcee. For example, the “Company 2” is extracted as a company that possesses the required technique and the required equipment related to the “part manufacturing” for the “Division Plan 2”. If a company that possesses both the required techniques and the required equipment cannot be found in the company information 113, the QCD evaluation unit 123 extracts a company that has more required techniques and required equipment, or extracts a company that has high similarities between the required techniques and possessed techniques, and between the required equipment and the possessed equipment. The similarity shall be determined by a known technique such as natural language processing, but the invention is not limited to this method.

In this case, it is necessary to add some equipment, but a cost required for adding the equipment will be reflected in estimation in the next step S004. A plurality of companies possessing the required techniques and the required equipment may exist in the company information 113. In that case, the QCD evaluation unit 123 extracts a company with a lower cost, a higher quality evaluation, and a shorter delivery LT, but the invention is not limited to this method and may extract based on other criteria. The QCD evaluation unit 123 stores an outsourcee in the extracted result in the matching information 116.

Next, the QCD evaluation unit 123 evaluates the company information 113 and the QCD of the division plans (step S004). Specifically, the QCD evaluation unit 123 reads out the matching information 116 and quantifies evaluations on the cost, the quality, and the delivery LT of each division plan.

Specifically, first, the QCD evaluation unit 123 extracts the outsourcee candidate companies extracted in each division plan from the matching information 116. For example, in the case of the “Division Plan 2”, the “Company 1” is extracted for the “product design”, the “Company 2” is extracted for the “part manufacturing”, the “Company 4” is extracted for the “finished product assembly”, and the “Company 3” is extracted for the “quality control”.

The QCD evaluation unit 123 refers to the company information 113 and extracts and adds the cost, the quality, and the delivery LT of the corresponding company in the production processes to quantify the cost, the quality, and the delivery LT in each division plan. For example, in the case of the “Division Plan 2”, the total cost is “product design by Company 1 ¥500,000+frame manufacturing by Company ¥100,000 (after discount applied ¥80,000)+motor manufacturing by Company 2 ¥400,000 (after discount applied ¥320,000)+control panel manufacturing by Company 2 ¥300,000 (after discount applied ¥240,000)+finished product assembly by Company 4 ¥90,000+quality control by Company 3 ¥150,000=¥1,540,000 (after discount applied ¥1380,000)”.

If additional equipment is required, in step S003, the QCD evaluation unit 123 uses the demand amount 111d of the request information 111 and the equipment capacity 114b of the equipment information 114 to calculate an additional cost of the equipment so that equipment capacity satisfies the demand, and adds the additional cost to obtain a final cost. The processing is also performed for all the division plans, a frequency distribution of the costs is generated, and scores are given according to the degree of variation in the distribution so that the lower the cost, the higher the score. In the case of the “Division Plan 2” above, a cost score is “50 scores” as shown in FIG. 8.

In the present embodiment, the evaluations are quantified according to the frequency distribution, but the invention is not limited to this method. The processing is performed for the quality and the delivery LT using predetermined index values, and scores are calculated for the quality and the delivery LT. The quality 113e of the company information 113 is evaluated regardless of numerical values such as “A” and “B”, but when totaling, the quality is quantified in advance such as “100 scores” for “A” and “80 scores” for “B”.

The QCD evaluation unit 123 totals scores of the cost, the quality, and the delivery LT to calculate a total score. For example, the QCD evaluation unit 123 calculates the total score as “50 scores+90 scores+80 scores=220 scores” in the case of the “Division Plan 2” in FIG. 8. The QCD evaluation unit 123 stores the calculation result in the QCD evaluation information 117.

In the processing, the QCD evaluation unit 123 not only calculates the total score by directly summing the scores of the cost, the quality, and the delivery LT as described above, but also can, for example, give a predetermined weight to the quality score when emphasizing the quality, or can weight an item to be emphasized. Accordingly, it is possible to determine a business outsourcee according to a request of each outsourcer, and a more useful coordinate is possible.

The outsourcee determination unit 124 determines an outsourcee (step S005). Specifically, the outsourcee determination unit 124 selects a division plan having a highest total score from the QCD evaluation information 117, and determines an outsourcee for each target process in the division plan. For example, in the case of the example of FIG. 8, the outsourcee determination unit 124 selects the “Division Plan 3” having the highest total score 117f. The outsourcee determination unit 124 extracts the outsourcee companies in the selected division plans from the matching information 116, and stores the result in the outsourcee information 118.

The input and output unit 130 outputs the result (step S006). Specifically, the input and output unit 130 uses the QCD evaluation information 117 and the outsourcee information 118 to generate an output screen 1400 showing information on the outsourcee companies and the QCD, and transmits and displays the output screen to the user terminal 103 via the network 102.

The above is an example of a flow of the value chain configuration processing. According to the value chain configuration processing, the request content can be divided according to the QCD and a combination of the outsourcees can be presented.

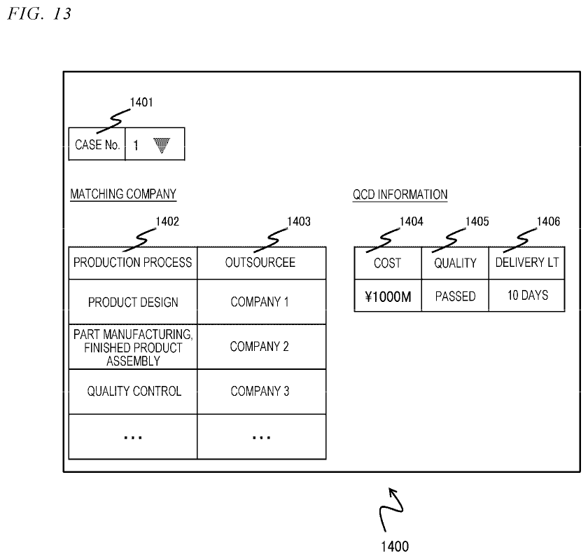

FIG. 13 is a diagram showing an example of the output screen. The output screen 1400 includes a case No. column 1401, a production process column 1402, an outsourcee column 1403, a cost column 1404, a quality column 1405, and a delivery LT column 1406.

Information on a case No. specified by the user is displayed in the case No. column 1401. The production processes according to the division plans of the case are displayed in the production process column 1402. Names of the outsourcee companies of the production processes in the production process column 1402 are displayed in the outsourcee column 1403. The total cost when requesting the companies in the outsourcee column 1403 is displayed in the cost column 1404. A comprehensive quality when requesting the companies in the outsourcee column 1403 is displayed in the quality column 1405. A comprehensive delivery LT when requesting the companies in the outsourcee column 1403 is displayed in the delivery LT column 1406.

The above is the business outsourcing management system according to the first embodiment. According to the business outsourcing management system 1, the request content can be divided according to the QCD and the combination of the outsourcees can be presented.

It should be noted that the invention is not limited to the embodiment described above and includes various modifications. For example, transportation may be regarded as an independent production process. In that case, a transportation cost may be estimated based on a transportation amount or may be calculated according to a distance between locations of outsourcee companies responsible for a pre-production process and a post-production process. By doing so, the cost and the delivery LT that are closer to an actual situation can be evaluated.

For example, regarding a quality control process, a control method may differ greatly depending on products, and thus, it is possible to classify the products in more detail and classify and assign skills possessed by an outsourcee according to types of the products. Thus, occurrence of mismatches and accidents due to reasons such as different industries can be prevented.

For example, when a product is manufactured across countries, for example, when importing and exporting of raw materials, importing and exporting of parts, shipping of the product, and the like need to cross countries, legal export restrictions such as the Foreign Exchange Law may be applied. In order to avoid such restrictions, export items and prohibition conditions are stored in the storage unit 110 in advance, and the required technique 111f of the request information 111 is limited to the implementing country, so that it can be excluded that the export to an outsourcee of a next process is subject to restriction.

For example, if it is necessary to evaluate creditworthiness of a business outsourcee, the QCD evaluation unit 123 may consider a rating rank in extraction criteria of the outsourcee by attaching a financial credit rating information from a rating agency to the company information. As a result, it is possible to avoid an unexpected default and increase a possibility of ensuring a stable supply of the product.

A part of a configuration of one embodiment could be replaced with a configuration of another embodiment, and the configuration of another embodiment could be added to the configuration of one embodiment.

In addition, apart of a configuration of each embodiment can be added, deleted, or replaced with another configuration.

A part or all of the above configurations, functions, processing units, processing sections, etc., may be implemented by hardware by designing an integrated circuit, etc. Each of the configurations, the functions, etc., described above may be implemented by software by interpreting and executing a program for implementing the respective functions by a processor. Information of the programs for achieving the respective functions, tables, files, etc., can be stored on recording devices such as a memory, a hard disk and an SSD or recording media such as an IC card, an SD card, and a DVD.

Control lines or information lines indicate what is considered necessary for explanation, and not all the control lines or information lines are shown in a product. In practice, it may be considered that almost all configurations are connected to each other by a communication network, a bus, or the like.

The technique according to the invention is not limited to the business outsourcing management system, and can be provided in various forms such as a cross-domain coordinating device, a server device, a computer-readable program, and a business outsourcing management method.

What is claimed is:

1. A business outsourcing management device, comprising:
a division plan derivation unit configured to derive a plurality of division plans in which a business related to manufacturing a product is divided into a plurality of processes;
an evaluation unit configured to extract and assign a company capable of responding to a requirement of the processes for each division plan and evaluate the division plans according to a predetermined index value; and
an outsourcee determination unit configured to determine a business outsourcee according to a division plan with a high evaluation among the division plans.

2. The business outsourcing management device according to claim 1, wherein
the evaluation unit uses a cost, a quality, and a period as the predetermined index values.

3. The business outsourcing management device according to claim 1, wherein
the evaluation unit uses a cost, a quality, and a period as the predetermined index values, and weights and evaluates an index value that is important in the business.

4. The business outsourcing management device according to claim 1, wherein
the evaluation unit uses a cost, a quality, and a period as the predetermined index values, and weights and evaluates an index value that is important in the business, and in calculation of the cost, regarding the company that does not satisfy a production amount required by the business, a cost of additional equipment for satisfying the production amount is included.

5. The business outsourcing management device according to claim 1, wherein
when performing the assignment, the evaluation unit sets a restriction on an implementing country in association with the process, so as to exclude a case where delivery to an outsourcee of a process following the process is subject to export restriction.

6. The business outsourcing management device according to claim 1, wherein
the company is attached with financial credit rating information from a rating agency, and
the evaluation unit uses the credit rating information in extracting the company.

7. A business outsourcing management method by a business outsourcing management device, comprising:
causing the business outsourcing management device to execute
a division plan derivation step of deriving a plurality of division plans in which a business related to manufacturing a product is divided into a plurality of processes;
an evaluation step of extracting and assigning a company capable of responding to a requirement of the processes for each division plan and evaluating the division plans according to a predetermined index value; and
an outsourcee determination step of determining a business outsourcee according to a division plan with a high evaluation among the division plans.
